(19) United States
(12) Patent Application Publication
(10) Pub. No.: US 2008/0270848 A1
(43) Pub. Date: Oct. 30, 2008

(54) Method and Apparatus for Displaying Pin Result Data

(76) Inventors: Carli Connally, Fort Collins, CO (US); Kristin Petersen, Clifton Park, NY (US)

Correspondence Address: Gregory W. Osterloth;Holland & Hart, LLP, P.O. Box 8749, Denver, CO, 80201, US

(21) Appl. No.: 11/740,778

(22) Filed: Apr. 26, 2007

(51) Int. Cl. G06F 11/00

(52) U.S. Cl. 714/46

(57) ABSTRACT

In one embodiment, a plurality of test data entries are successively displayed via a graphical user interface (GUI), with each of the test data entries including at least a test result identifier and a corresponding test result. At least one user-selectable mechanism is provided via the GUI. When one of the user-selectable mechanisms is selected, hidden pin result data related to at least one of the test data entries is caused to be displayed via the GUI. Other embodiments are also disclosed.

### BACKGROUND

When testing circuit devices such as system-on-a-chip (SOC) devices, various types of test data may be logged, including pin result data (i.e., test data for particular pins of a device under test). However, pin result data is typically not displayed to a user because it does not fit cleanly into a tabular format, and it can increase the volume of displayed test data by 500 times or more.

### BRIEF DESCRIPTION OF THE DRAWINGS

Illustrative embodiments of the invention are illustrated in the drawings, in which:

FIG. 1 illustrates an exemplary method for displaying pin result data; and

FIGS. 2 & 3 illustrate exemplary states of a GUI via which the method shown in FIG. 1 may be implemented.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

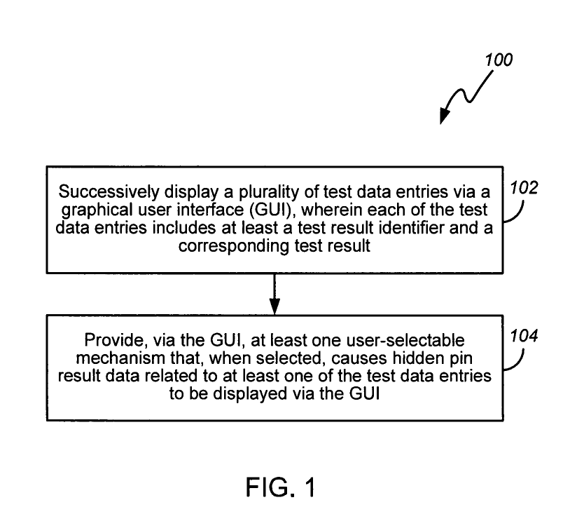

In accord with one embodiment of the invention, FIG. 1 illustrates a computer-implemented method 100 in which a plurality of test data entries (for tests or measurements) are successively displayed via a graphical user interface (GUI). See, block 102. Each of the test data entries includes at least a test result identifier and a corresponding test result. In one embodiment, the test data entries may pertain to tests of a system-on-a-chip (SOC) device, such as tests that have been executed by the V93000 SOC tester distributed by Verigy Ltd. However, the test data entries could also pertain to tests that are executed by other sorts of testers, or tests that are executed on other sorts of circuit devices. In one embodiment, the items of test data included in the test data entries may be provided by, or derived from, one of the data formatters disclosed in the United States patent application of Connally, et al. entitled “Apparatus for Storing and Formatting Data” (Ser. No. 11/345,040).

Some of the test data entries that are displayed during execution of the method 100 may correspond to single test results, whereas other entries may correspond to subsets of test results, such as a number of test results generated by performing the same test on a plurality of device pins. By way of example, the test result identifiers may comprise test names or test numbers; and the test results may comprise pass/fail indications or measurements. Test data entries may also include other data items, such as test limits (e.g., if a test is a measurement).

At least one user-selectable mechanism, such as a graphical button, is provided via the GUI (see, block 104). When the user-selectable mechanism is selected, hidden pin result data related to at least one of the test data entries is caused to be displayed via the GUI. As will be described in more detail below, some of the user-selectable mechanisms may be associated with particular ones of the test data entries, and their selection may cause hidden pin result data to be displayed for the particular ones of the test data entries. One or more of the user-selectable mechanisms may also be global mechanisms, such that they cause hidden pin result data to be displayed for all test data entries.

The method 100 is useful, in one respect, in that top-level test data entries can be displayed to a user by default, and pin result data that a user may or may not want to see can be hidden, thereby keeping the “clutter” of pin result data out of the default display. This is significant because, in the past, test data has typically been displayed in bulk form and not as individual “entries” that could be assigned different properties (such as visible or hidden). Thus, in the past, a user that desired to see pin result data was forced to view pin result data that was intermingled, in bulk, with other test data. Given that the display of pin result data can sometimes expand the amount of data that needs to be displayed by as much as 500 times (or more), the “other” test data was sometimes hard to locate using previous test data display methods.

The method 100 shown in FIG. 1 may be implemented by means of computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer readable code will typically comprise software, but could also comprise firmware or a programmed circuit.

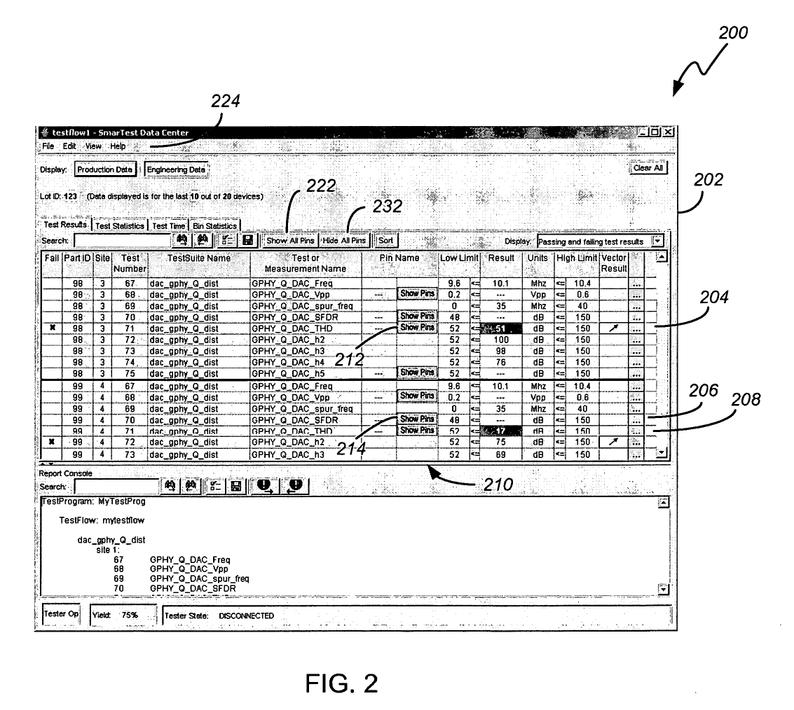

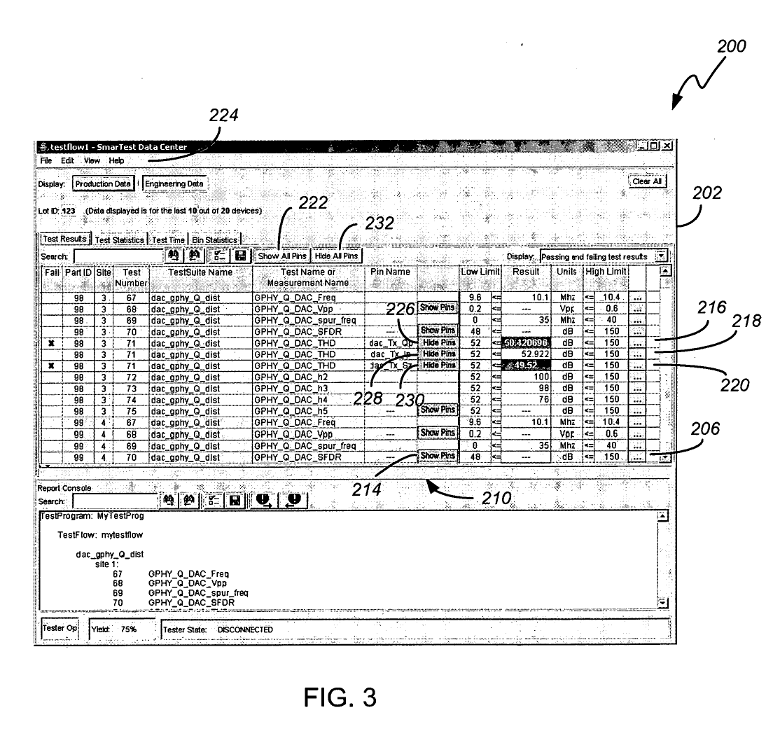

FIGS. 2 and 3 illustrate exemplary states of a GUI 200 via which the method 100 may be implemented. As shown in FIG. 2, a plurality of test data entries, such as entries 204, 206, 208, are displayed via a window 202. By way of example, each test data entry 204, 206, 208 comprises three test result identifiers, including: a “Test Number”, a “Test or Measurement Name”, and a “TestSuite Name” that identifies a test suite to which the test name and number belong. In addition, each test data entry 204, 206, 208 comprises: information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or non-volatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar may be provided to allow a user to navigate to different test data entries or items.

As further shown in FIG. 2, each of the test data entries may be displayed as a line of a table 210, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

The exemplary GUI 200 provides two different categories of user-selectable mechanism for triggering the display of hidden pin result data. The first category comprises one or more “local” mechanisms 212, 214, each of which, when individually selected, causes hidden pin result data to be displayed for a different test data entry 204, 206, 208. By way of example, one of the “local” mechanisms is implemented via the GUI 200 as button 212. As shown, the button 212 is associated with (and preferably included in) a line of the table 210 that corresponds to a particular test data entry 206. The button 212 carries the label “Show Pins” and, when graphically selected or pressed by a user, causes a plurality of new lines 216, 218, 220 to be inserted in the table 210. See, FIG. 3. Formerly hidden pin result data can then be displayed via the additional table lines 216, 218, 220. Preferably, pin result data for different pins is displayed in different ones of the additional lines 216, 218, 220.

When hidden pin result data exists for a test data entry 204, and when different pins are associated with different results, the result(s) that are displayed with the test data entry 204 (i.e., when the pin result data is hidden) can take various forms. In one embodiment, a result field of the table line corresponding to the test data entry 204 (e.g., the “Fail” field or the “Result” field in FIG. 2) could simply be left empty when hidden pin result data exists. In another embodiment, a result field (e.g., the “Fail” field) could display a pass/fail indication corresponding to a first of a number of pins that are represented by hidden pin result data. Alternately, a result field (e.g., the “Fail” field) could display a global pass/fail indication for the hidden pin result data (i.e., if one pin is associated with a fail indication, the “Fail” field could indicate a failure for a set of pins as a whole). In yet another embodiment, a result field (e.g., the “Result” field) could display 1) a numerical test result corresponding to a first of a number of pins that are represented by hidden pin result data, or 2) a numerical test result corresponding to a first pin to fail, if any. A result field (e.g., the “Result” field) could also display a numerical test result that is an average or some other sort of combination of all numerical test results for all pins represented by the hidden pin result data.

When hidden pin result data is available for each of a plurality of test data entries 204, 206, 208, a different user-selectable mechanism, such as button 212 or button 214, may be associated with each of the test data entries 204, 206, 208. Preferably, however, a button is only associated with a table line (e.g., shown or enabled) when hidden pin result data is available for the test data entry that is represented by the table line. For other table lines, a field for such a button may be provided, but the button itself may not be shown or enabled. Alternately, a button could be displayed for each test data entry 204, 206, 208 of the table 210, and use of one of the buttons when hidden pin result data is unavailable could simply cause the display of a “no results” message.

The second category of user-selectable mechanism provided by the GUI 200 is a “global” category. The mechanisms of this category, such as button 222, enable the display of hidden pin result data for all test data entries 204, 206, 208. That is, all of the pin result data for all of the test data entries 204, 206, 208 in the table 210 is caused to be displayed with one action, and a user may then scroll through all pin result data for all test data entries.

Instead of, or in addition to, implementing user-selectable mechanisms for obtaining hidden pin result data as buttons 212, 214, 222, the GUI 200 can provide other sorts of user-selectable mechanisms. For example, the GUI 200 can implement a “local” user-selectable mechanism as a menu item that is obtained, for example, by 1) right-clicking on a particular test data entry 204 (e.g., a line of the table 210 shown in FIG. 2) to obtain a pop-up menu, or by 2) selecting a test data entry 204 and then clicking on a drop-down menu header of a menu bar 224. Similarly, the GUI 200 can implement a “global” user-selectable mechanism as a menu item that is obtained by clicking on a drop-down menu header of a menu bar 224.

Although the above-described mechanisms require different numbers of steps for accessing the “hidden pin result data” that pertains to a particular test data entry, it is noted that those requiring only a single graphical pointer click may be preferred.

In addition to providing user-selectable mechanisms 212, 214, 222 that enable the display of pin result data, the GUI 200 can also provide user-selectable mechanisms 226, 228, 230 that enable the hiding of pin result data. FIG. 3 illustrates various buttons 226, 228, 230 that are associated with particular lines 216, 218, 220 of the table 210, and that, when graphically selected, cause displayed pin result data to be hidden. For example, use of one of the buttons 226, 228, 230 causes all pin result data corresponding to the test data entry 204 to be hidden. Table lines that were used to display the pin result data are also hidden (or deleted).

FIGS. 2 & 3 also illustrate a button 232 that allows pin result data to be hidden on a global basis (i.e., for all test data entries). That is, a graphical click on the button 232 causes all pin result data, for all of the test data entries 204, 206, 208 in the table 210, to be hidden.

In addition to buttons 226, 228, 230 and 232, user-selectable mechanisms for hiding pin result data may take other forms, such as the menu-based forms that have been described for triggering the display of pin result data.

What is claimed is:

1. A computer-implemented method, comprising:
successively displaying a plurality of test data entries via a graphical user interface (GUI), wherein each of the test data entries includes at least a test result identifier and a corresponding test result; and
providing, via the GUI, at least one user-selectable mechanism that, when selected, causes hidden pin result data related to at least one of the test data entries to be displayed via the GUI.

2. The method of claim 1, further comprising, providing at least one of the user-selectable mechanisms as a button that enables hidden pin result data to be displayed for all of the test data entries.

3. The method of claim 1, further comprising, providing, via the GUI, at least one user-selectable mechanism that, when selected, causes displayed pin result data to be hidden for at least one of the test data entries.

4. The method of claim 3, further comprising, providing at least one of the user-selectable mechanisms as a button that enables displayed pin result data to be hidden for all test data entries.

5. The method of claim 1, wherein the at least one user-selectable mechanism comprises a plurality of user-selectable mechanisms that, when individually selected, cause hidden pin result data to be displayed for different ones of the test data entries.

6. The method of claim 5, further comprising, only associating one of the plurality of user-selectable mechanisms with a particular one of the test data entries when hidden pin result data is available for the particular one of the test data entries.

7. The method of claim 1, further comprising:
displaying the plurality of test data entries in a table, wherein different lines of the table correspond to different ones of the test data entries; and
upon selection of one of the user-selectable mechanisms, inserting a plurality of new lines in the table, and displaying pin result data for different pins in different ones of the new lines.

8. The method of claim 7, further comprising:
only associating ones of the user-selectable mechanisms with particular ones of the test data entries for which hidden pin result data is available; and
providing the ones of the user-selectable mechanisms that are associated with the particular ones of the ones of the test data entries as buttons that are associated with ones of the lines of the table.

9. The method of claim 7, further comprising, displaying in a line of the table corresponding to a test data entry that is associated with hidden pin result data, an empty result field.

10. The method of claim 7, further comprising, displaying in a line of the table corresponding to a test data entry that is associated with hidden pin result data, a result field displaying a pass/fail indication corresponding to a first of a number of pins represented by the hidden pin result data.

11. The method of claim 7, further comprising, displaying in a line of the table corresponding to a test data entry that is associated with hidden pin result data, a result field displaying a global pass/fail indication for the hidden pin result data.

12. The method of claim 7, further comprising, displaying in a line of the table corresponding to a test data entry that is associated with hidden pin result data, a result field displaying a numerical test result corresponding to a first pin to fail, if any.

13. The method of claim 7, further comprising, displaying in a line of the table corresponding to a test data entry that is associated with hidden pin result data, a result field displaying a numerical test result that is a combination of all numerical test results for all pins represented by the hidden pin result data.

14. The method of claim 1, further comprising, beginning the successive display of the plurality of test data entries during execution of a plurality of tests on which the test data entries are based.

15. A computer-implemented method, comprising:
successively displaying a plurality of test data entries via a graphical user interface (GUI), wherein each of the test data entries includes at least a test result identifier and a corresponding test result; and
providing, via the GUI, at least one user-selectable mechanism that, when selected, causes displayed pin result data related to at least one of the test data entries to be hidden.

16. Apparatus, comprising:
computer-readable media;
computer-readable code, stored on the computer-readable media, including,
code to cause a computer to successively display a plurality of test data entries via a graphical user interface (GUI), wherein each of the test data entries includes at least a test result identifier and a corresponding test result; and
code to provide, via the GUI, at least one user-selectable mechanism that, when selected, causes hidden pin result data related to at least one of the test data entries to be displayed via the GUI.

17. The apparatus of claim 16, further comprising:
code to cause the computer to display the plurality of test data entries in a table, wherein different lines of the table correspond to different ones of the test data entries; and
code to cause the computer to, upon selection of one of the user-selectable mechanisms, i) insert a plurality of new lines in the table, and ii) display pin result data for different pins in different ones of the new lines.

18. The apparatus of claim 17, further comprising:
code to only associate ones of the user-selectable mechanisms with particular ones of the test data entries for which hidden pin result data is available; and
code to provide the ones of the user-selectable mechanisms that are associated with the particular ones of the ones of the test data entries as buttons that are associated with ones of the lines of the table.

19. The apparatus of claim 16, wherein at least one of the user-selectable mechanisms is operable via a single graphical pointer click.

20. The apparatus of claim 16, wherein the test result identifiers comprise test numbers.

21. The apparatus of claim 16, wherein the test result identifiers comprise test names.

22. The apparatus of claim 16, wherein the test data entries pertain to tests of a system-on-a-chip (SOC) device.
